(19) United States
(12) Patent Application Publication
(10) Pub. No.: US 2015/0294400 A1
(43) Pub. Date: Oct. 15, 2015

(54) METHODS AND SYSTEMS FOR ONLINE COLLECTIONS

(71) Applicant: EBAY INC., San Jose, CA (US)

(72) Inventors: Brian Williams, San Jose, CA (US); Corey Chandler, San Jose, CA (US); Dane Howard, San Jose, CA (US); Luke Peacock, San Jose, CA (US); Karenina Susilo, San Jose, CA (US); Peter Liljegren, San Jose, CA (US); Roel Ramirez, San Jose, CA (US)

(21) Appl. No.: 14/749,361

(22) Filed: Jun. 24, 2015

Related U.S. Application Data
(63) Continuation of application No. 12/415,967, filed on Mar. 31, 2009.

(51) Int. Cl. G06Q 30/06

(52) U.S. Cl. CPC G06Q 30/0643

(57) ABSTRACT

Embodiments of the present disclosure provide methods and systems for creating and managing online collections. In one embodiment, a system comprises: a client device in communication with a business entity server through a network, wherein a user of the client device is able to create and manage collections based on items, products and/or services selected from the business entity server on a stage displayed on the client device, and wherein the collections are adapted to be saved such that arrangement and data associated with the items, products and/or services are persisted into the collection.

### CROSS-REFERENCE TO RELATED APPLICATION

This application is a continuation of U.S. patent application Ser. No. 12/415,967, filed Mar. 31, 2009, which is incorporated herein by reference in its entirety.

### BACKGROUND

1. Technical Field

Embodiments of the present disclosure generally relate to methods and systems for electronic commerce, and more particularly, to methods and systems for creating and managing online collections.

2. Related Art

With the expansion of Internet commerce, consumers can easily and readily purchase items and services throughout the world. Consumers locate or identify a desired item or service on the Internet, such as with a personal computer (PC), laptop, personal digital assistant (PDA), mobile phone, or other suitable device. The consumer can then make the purchase by entering the amount of money to be transferred to the seller. For example, a consumer may search and select the color or size of a clothing item before paying for the item.

Consumers may also bid on items online, where such bids do not represent a completed transaction, but simply a promise to pay that amount if the bid is the high bid.

However, there's something missing from online shopping experiences today. Although current Internet commerce enables a consumer to search through a wealth of inventory in many different existing websites, and a consumer may also be able to see pictures of items that he or she is considering buying, Internet commerce may lead to difficulties, for example, in predicting the appearance of the items, comparing items side by side or getting the reaction from friends.

### SUMMARY

Embodiments of the present disclosure provide systems and methods for creating and managing collections online including the collecting, arranging and persistence of multiple e-commerce items on a stage wherein an online user may enjoy an enhanced e-commerce experience.

According to one embodiment of the present disclosure, a system comprises a client device in communication with a business entity server through a network, wherein a user of the client device is able to create and manage collections based on items, products and/or services selected from the business entity server on a stage displayed on the client device, and wherein the collections are adapted to be saved such that arrangement and data associated with the items, products and/or services are persisted into the collection.

According to an embodiment of the present disclosure, a method for creating and managing online collections comprises moving one or more items, products and/or services selected from a website provided by a business entity through a network to a stage displayed on a client device. The method also comprises manipulating the selected one or more items, products and/or services on the stage to create collections. The method further comprises saving the collections wherein arrangement and data associated with each of the items, products and/or services are persisted into the collections.

According to an embodiment of the present disclosure, software encoded in one or more computer readable media that when executed is operable to move one or more items, products and/or services selected from a website provided by a business entity through a network to a stage displayed on a client device; manipulate the selected one or more items, products and/or services on the stage to create collections; and save the collections wherein arrangement and data associated with each of the items, products and/or services are persisted into the collections.

According to an embodiment of the present disclosure, a client device comprises a processor configured to move one or more items, products and/or services selected from a website provided by a business entity through a network to a stage adaptable to manipulate the one or more items, products and/or services to form collections and to save the collections persisting arrangement and data of the one or more items, products and/or services used in the collection. The client device also comprises a display showing visual representation of various configurations of the processor.

This disclosure will be more fully understood in light of the following detailed description taken together with the accompanying drawings.

### BRIEF DESCRIPTION OF THE DRAWINGS

FIG. 1 illustrates a block diagram of a system adapted to create and manage collections of e-commerce items, in accordance with an embodiment of the present disclosure;

FIG. 2 illustrates a block diagram for selecting an item icon from a merchant item list and moving the selected item icon to a collection tray, in accordance with an embodiment of the present disclosure;

FIG. 3 illustrates an example of an expanded stage of the collection tray 240 of FIG. 2 according to an embodiment of the present disclosure;

FIG. 4 illustrates an example of a screen shot of a “saving” operation for a new collection according to an embodiment of the present disclosure;

FIG. 5 illustrates an example of a screen shot of a presentation of a new collection according to an embodiment of the present disclosure;

FIG. 6 is a flowchart illustrating an e-commerce experience for creating and managing a collection according to an embodiment of the present disclosure; and

FIG. 7 is a block diagram of a system suitable for implementing embodiments of the present disclosure.

It should be appreciated that like reference numerals are used to identify like elements illustrated in one or more of the figures.

### DETAILED DESCRIPTION

Embodiments of the present disclosure are directed to systems and methods that bring a crucial part to the online shopping experience. In contrast to online shopping experiences today, embodiments of the present disclosure provide systems and methods wherein a user may not only search through a wealth of online inventory and see photos of objects that the user is considering buying, but the user may also, for example, pick up an item, see it up close, turn it around, and put it next to something else the user is considering buying to compare the items. In the clothing context, for example, a user may bring an entire outfit into an online stage or dressing room to see if the whole ensemble works together and may share the experience with friends to get their reaction when emerging from the dressing room.

Although embodiments of the present disclosure described herein may be directed to items, products and/or services in the clothing context, it should be understood that embodiments of the present disclosure may also provide and be directed to a variety of other items, products and/or services in other contexts such as home decor, automotive parts, or any other contexts suitable for online shopping or electronic commerce.

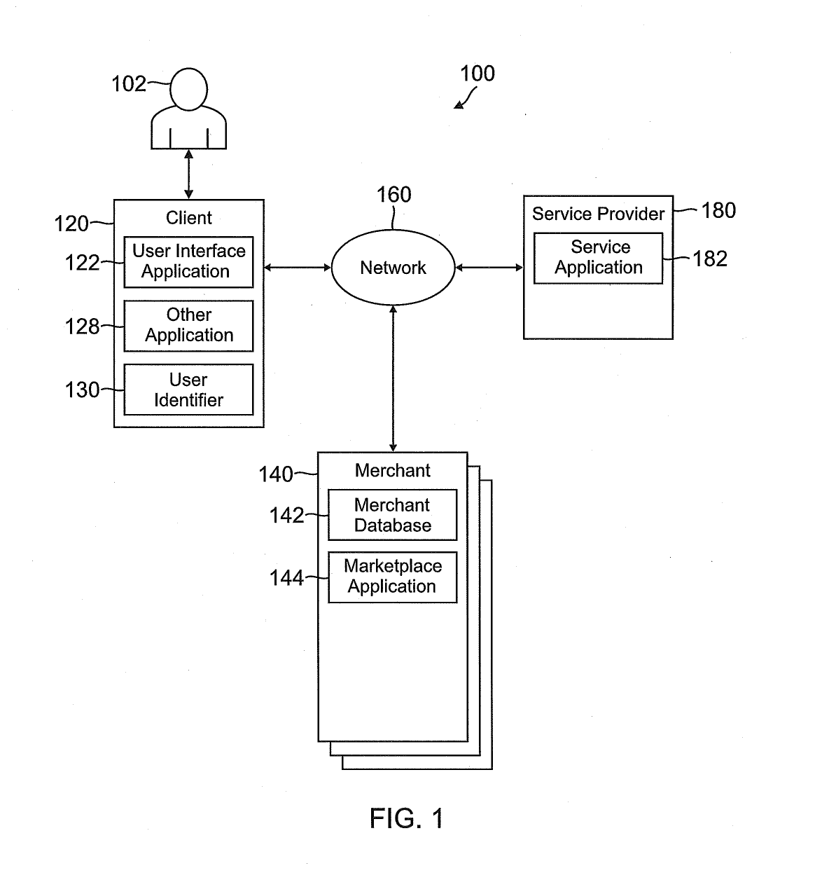

Referring to FIG. 1, a block diagram of a system 100 adapted to create and manage collections of e-commerce items, products and/or services over a network 160 is illustrated in accordance with an embodiment of the present disclosure.

As shown in FIG. 1, system 100 includes at least one client device 120 (e.g., network computing device), one or more merchant devices 140 (e.g., network server devices), and at least one service provider device 180 (e.g., network server device) in communication over network 160.

Network 160, in one embodiment, may be implemented as a single network or a combination of multiple networks. For example, in various embodiments, network 160 may include the Internet and/or one or more intranets, landline networks, wireless networks, and/or other appropriate types of communication networks. In another example, network 160 may comprise a wireless telecommunications network (e.g., cellular phone network) adapted to communicate with other communication networks, such as the Internet. As such, in various embodiments, client device 120, merchant servers 140, and service provider 180 may be associated with a particular link (e.g., a link, such as a URL (Uniform Resource Locator) to an IP (Internet Protocol) address).

Client device 120, in various embodiments, may be implemented using any appropriate combination of hardware and/or software configured for wired and/or wireless communication over network 160. In one example, client device 120 may be implemented as a personal computer (i.e., PC) in communication with network 160, such as the Internet. In various other examples, client device 120 may be implemented as a wireless telephone (e.g., cellular phone), a personal digital assistant (PDA), a notebook computer, and/or various other generally known types of wired and/or wireless computing devices.

Client device 120, in one embodiment, includes a user interface application 122, which may be utilized by a user 102 to conduct financial transactions (e.g., shopping, purchasing, bidding, etc.), for example, with service provider server 180 over network 160.

In one implementation, user interface application 122 comprises a software program, such as a graphical user interface (GUI), executable by a processor that is configured to interface and communicate with service provider server 180 via network 160. In another implementation, user interface application 122 comprises a browser module that provides a network interface to browse information available over network 160. For example, user interface application 122 may be implemented, in part, as a web browser to view information available over network 160. In another example, user 102 is able to access merchant websites via the one or more merchant servers 140 to view and select items, products, and/or services for purchase, and user 102 is able to purchase items, products, and/or services from the one or more merchant servers 140 via, for example, service provider server 180. Accordingly, user 102 may conduct financial transactions (e.g., purchase and provide payment for items, products, and/or services) from the one or more merchant servers 140 via service provider server 180.

Client device 120, in various embodiments, may include other applications 128 as may be desired in one or more embodiments of the present disclosure to provide additional features available to user 102 such as, for example, security applications for implementing client-side security features, programmatic client applications for interfacing with appropriate application programming interfaces (APIs) over network 160, and/or various other types of generally known programs and/or software applications. In still other examples, the other applications 128 may interface with the user interface application 122 for improved efficiency and convenience.

Client device 120, in one embodiment, may include at least one user identifier 130, which may be implemented, for example, as operating system registry entries, cookies associated with user interface application 122, identifiers associated with hardware of client device 120, or various other appropriate identifiers.

The one or more merchant servers 140, in various embodiments, may be maintained by one or more business entities (e.g., merchant sites, resource information sites, utility sites, real estate management sites, social networking sites, etc.) offering various items, products, and/or services for purchase and payment, which may need registration of the user identity information as part of offering the items, products, and/or services to user 102 over network 160. As such, each of the one or more merchant servers 140 may include a merchant database 142 for identifying available items, products, and/or services, which may be made available to client device 120 for viewing and purchase by user 102.

Each of the merchant servers 140, in one embodiment, may include a marketplace application 144, which may be configured to provide information over network 160 to the user interface application 122 of client device 120. For example, user 102 may interact with marketplace application 144 through user interface application 122 over network 160 to search and view various items, products, and/or services available for purchase in the merchant database 142.

Service provider server 180, in one embodiment, may be maintained by an online transaction processing entity, which may provide processing for online financial transactions and/or information transactions between user 102 and one or more of the merchant servers 140. As such, service provider server 180 includes a service application 182, which may be adapted to interact with each client device 120 and/or each merchant server 140 over network 160 to facilitate the selection, purchase, and/or payment of items, products, and/or services by user 102 from one or more of the merchant servers 140. In one example, service provider server 180 may be provided by PayPal, Inc. and/or eBay of San Jose, Calif., USA.

In accordance with one or more embodiments of the present disclosure, when a user runs system 100 illustrated in the embodiment of FIG. 1, the system may display a screen on the user's client device 120 wherein online or network-based business entities (e.g., merchant sites, resource information sites, utility sites, real estate management sites, social networking sites, etc.) offer selections of items, products, and/or services for users to view, select, monitor and/or purchase. For example, in the clothing context, a user may search for, view and navigate multiple clothing items such as t-shirts, jeans, shoes, belts, etc. intra-SKU that are available for viewing and purchasing in one or more business entities' sites. In one aspect, the user may further search for, view and navigate specific item characteristics such as one or several colors or sizes for each item offered by the online business entities.

Once a user searches, views and/or navigates items, products and/or services offered by online or network-based business entities, a user may select one or more items, products and/or services and decide to move them into a collection tray for later use as described herein.

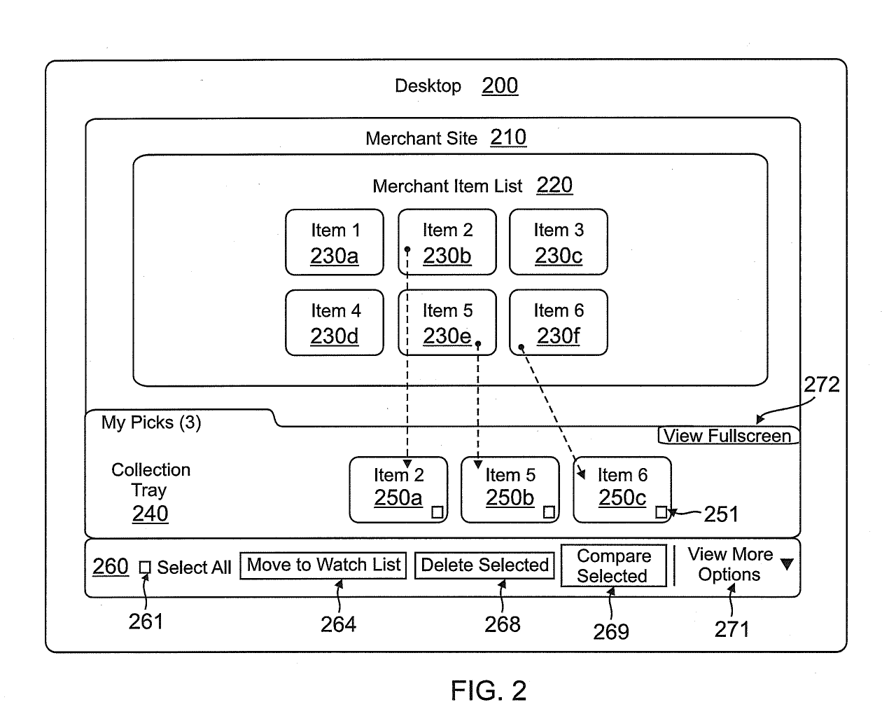

FIG. 2 illustrates one embodiment for selecting an item icon from a business entity site and moving the selected item icon to a collection tray, in accordance with an embodiment of the present disclosure.

As illustrated in FIG. 2 according to an embodiment, an image of a client device, which in this embodiment is illustrated as a computer desktop 200, displays a browser window 210 of a merchant site with a merchant item list 220 having one or more item icons 230a-230f as part thereof.

User 102 may select an item icon 230a-230f from merchant item list 220 and move (e.g., drag and drop) the selected item icon 230a-230f into a collection tray 240 (that may be tabbed or labeled, for example, as “My Picks”) as displayed in desktop 200. In one implementation, referring to FIGS. 1 and 2, user 102 utilizes the browser application 122 to open the browser window 210 of the merchant site and access a merchant server 140 via a merchant site to view the merchant item list 220 having the one or more items (i.e., item icons 230a-230f) for viewing, selection, and/or purchase. When executed, the user interface application 122 is adapted to provide the collection tray 240 on the desktop environment 200 so that user 102 may select and drag at least one item icon 230a-230f to the collection tray 240. Collection tray 240, which may be tabbed as “My Picks,” may have one or more items selected and dragged into the collection tray 240 from the merchant item list 220. For example, in the embodiment of FIG. 2, three items, Item 2 (230b), Item 5 (230e) and Item 6 (230f) are selected and dragged from merchant item list 220 into collection tray 240. Item 2 (250a), Item 5 (250b) and Item 6 (250c) are then displayed in collection tray 240 once those items have been selected and dragged therein.

User 102 may drop one or more selected item icons anywhere within the collection tray 240. User 102 has the ability to select and drag items into the collection tray 240, which then allows the user to use those items later. Items in the collection tray 240 may be sorted, organized and/or filtered in order to locate desired items. Collection tray 240 may be used in combination with other inventory, and illustrates the personalization of user 102.

In one embodiment, referring to FIG. 2, a display component of client device 120 may be adapted to display, in an environment of the computer desktop 200, the merchant site in the browser window 210, the item list 220 having the one or more of the item icons 230a-230f, and the collection tray 240 having the selected and dragged items 250a-250c.

A display component of the client device may also be adapted to display in the desktop environment 200, according to an embodiment, a toolbar 260 in the browser window 210 with one or more user selectable operations including a “Select all” operation 261, which allows user 102 to select all the item icons present in collection tray 240 at once. Execution of “Select all” operation 261 would be indicated by each item icon select operation 251 in the collection tray 240 being marked, for example, by a check-mark. Toolbar 260 may also include a “Move-to-Watch-List” operation 264, which allows user 102 to move or transfer one or more items (i.e., item icons 250a-250c) to a watch list (not shown), which allows user 102 to monitor the items, e.g., for price increases, price decreases, item availability, etc. In one aspect, the watch list may comprise another website or window having a watch list of items that user 102 wants to store or save for further processing at another time. Toolbar 260 may further include a “Compare Selected” operation 269 that allows the user to select one or more item icons 250a-250c to compare and/or contrast as will be described herein, and a “Delete Selected” operation 268, which allows user 102 to clear one or more item icons 250a-250c from the collection tray 240 by, e.g., removing the item icons from the collection tray 240 that are marked as indicated by item icon select operation 251. A “More Options” pull down menu 271 may also be available on toolbar 260.

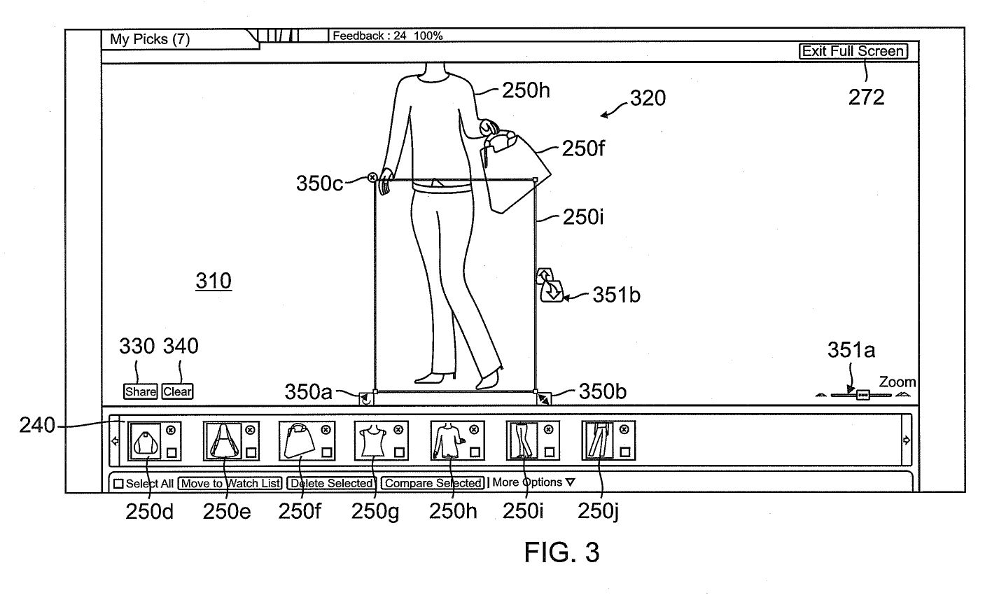

A “View FullScreen” operation 272 allows user 102 to expand or contract (i.e., minimize or maximize) the collection tray 240 as desired, and when contracted or minimized, the user 102 may drag-and-drop one or more item icons 230a-230f onto the contracted or minimized collection tray 240. An example of an expanded view of collection tray 240 will be described with reference to FIG. 3 herein.

Referring to FIG. 3, an example of an expanded stage of the collection tray 240 of FIG. 2 is illustrated according to an embodiment of the present disclosure.

In the example of FIG. 3, collection tray 240 is illustrated in the context of clothing or an online dressing room. However, it should be noted that embodiments of the present disclosure may also be directed to contexts other than clothing, for example, home decor, automotive parts, or other contexts that are suitable for online shopping or e-commerce.

In this example, seven icon items 250d-250j representing various clothing items that were selected and dragged by a user into the collection tray 240 are illustrated. In FIG. 2, user 102 may expand or maximize collection tray 240 via the “View Full Screen” operation. Conversely, in FIG. 3, user 102 may contract or minimize collection tray 240 via the “Exit Full Screen” operation 272. By expanding the collection tray 240 via the “View Full Screen” operation, user 102 has the added ability to move, for example by selecting and dragging, one or more of icon items 250d-250j from collection tray 240 directly into a stage 310 where the icon items may be manipulated as described herein.

It should be noted that FIG. 3 is only one example of a view or display of collection tray 240 and stage 310 wherein collection tray 240 is positioned at a bottom portion below stage 310. In other embodiments, stage 310 may be a destination page or a layer within an e-commerce experience. In still other embodiments, collection tray 240 may be positioned, for example, on a left side or a right side of stage 310. Furthermore, tabs of icon items (or inventory) may represent a series of services ranging from the collection tray to specific inventory, to related (or similar) inventory, or to inventory specific to the user's credentials and access.

Stage 310 may function like an online dressing room that allows user 102 to build a collection or outfit 320 at any time in order to leverage the items available in collection tray 240. One or more of icon items 250d-250j selected and dragged by user 102 into stage 310 may be manipulated to make up the collection or outfit 320.

Stage 310 may be freeform, that is, it allows user 102 to manipulate, including dragging, rotating, resizing and/or layering the one or more icon items, for example icon items 250d-250f, in stage 310 in order to create a new persistent set of data forming the collection or outfit 320. For example, operations 350a-350c may be used to manipulate any of item icons 250d-250f, which were selected and dragged into stage 310, so that those item icons may be sized, rotated, or layered to create outfit 320. Technologies such as Flash/Flex or JavaScript may be used in implementing stage 310.

In this example of FIG. 3, in stage 310, icon item 250f represents a purse or handbag positioned next to icon item 250h, which represents a long-sleeved shirt positioned on top of icon item 250i, wherein those icon items have been selected and dragged into stage 310 and may be positioned, rotated, resized or layered via operations 350a-350c to build collection or outfit 320.

Each icon item 250d-250j that has been used and/or manipulated to build collection or outfit 320 in stage 310 maintains or preserves its respective information, for example, metadata associated with each item. Therefore, because each icon item may be associated with, for example, a SKU, an icon item on stage 310 may be represented with, for example, any color or size available for that particular icon item.

Stage 310 may comprise additional controls that assist the navigation of stage 310 including zoom, center and panning controls. For example, a dynamic zoom operation 351a may be used to zoom in or zoom out for viewing outfit 320 in stage 310. Stage 310 may also be panned and controlled by, for example, operation 351b. Stage 310 may comprise, for example, a VUVOX editing tool.

Furthermore, in stage 310, additional technology may automatically remove or extract backgrounds or solid colors, for example, white, a wall, the floor, etc., that may exist in photographs or image thumbnails of icon items 250d-250j so that the layering and overlapping of icon items 250d-250j on stage 310 have a more seamless composition without any background or solid colors, thus enhancing the visual experience.

A “Clear” button 340 on stage 310 may be used to clear or remove outfit 320 or icon items thereof from stage 310.

Once a collection or outfit 320 is completed in stage 310, persisting the arrangement or collection may be executed by pressing a “saving” control, for example, by executing the “Share” operation 330, which may also be referred to as a “Save” operation. In other embodiments, saving or persisting a collection or outfit 320 may also be done automatically. Persisting the arrangement or collection allows the entire collection and attributes to be written as a new collection or object. Persisting the data into a new collection or object keeps track of the arrangement and icon items or inventory therein as used for outfit 320.

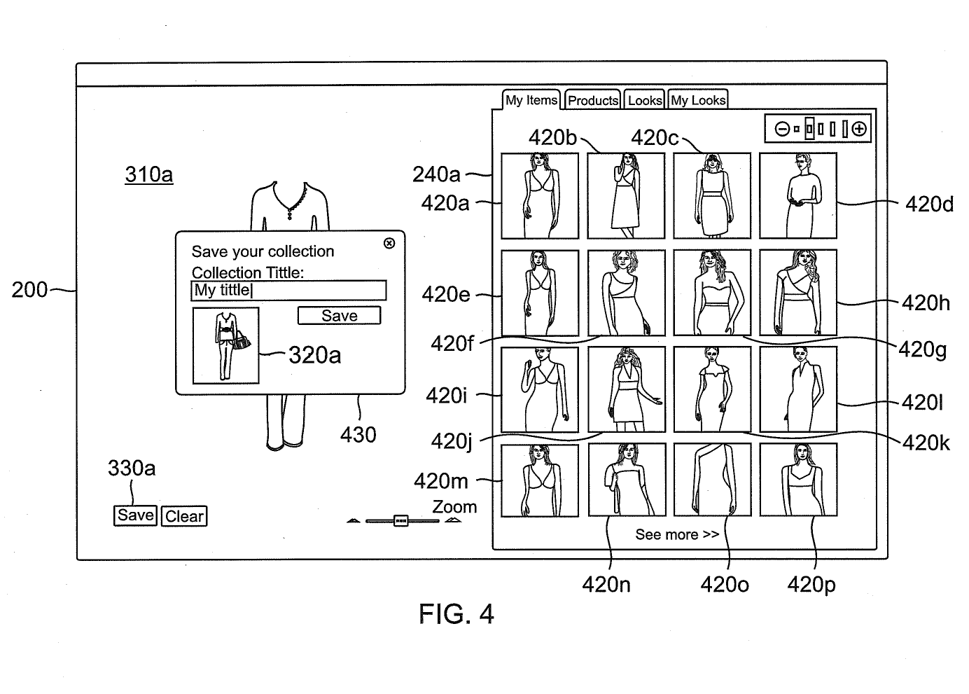

FIG. 4 illustrates an example of a screen shot of a “saving” operation for a new collection in the clothing context according to an embodiment of the present disclosure.

FIG. 4 illustrates an image of a client device, which in this embodiment is illustrated as a computer desktop 200, displaying a portion of a plurality of tabs of inventory or items 420a-420p that may be placed in a collection tray 240a. The collection tray 240a may be tabbed as “My Items,” and may contain many more items other than the plurality of tabs of inventory or items 420a-420p, which a user has selected from viewing and searching, for example, various online or network-based business entities' sites. Similar to the description above with respect to the embodiment of FIG. 3, a user may add one or more items 420a-420p from collection tray 240a into stage 310a to build a collection or outfit 320a. Once a collection or outfit 320a is completed, and a user executes a “Save” operation 330a, a dialog box 430 appears on the display of desktop 200 so that the user may save the collection under a chosen “Collection Title.” Persisting the arrangement or collection by executing “Save” operation 330a, allows the entire collection and associated attributes including associated information such as metadata for each item forming the collection to be written as a new collection or object under the chosen title.

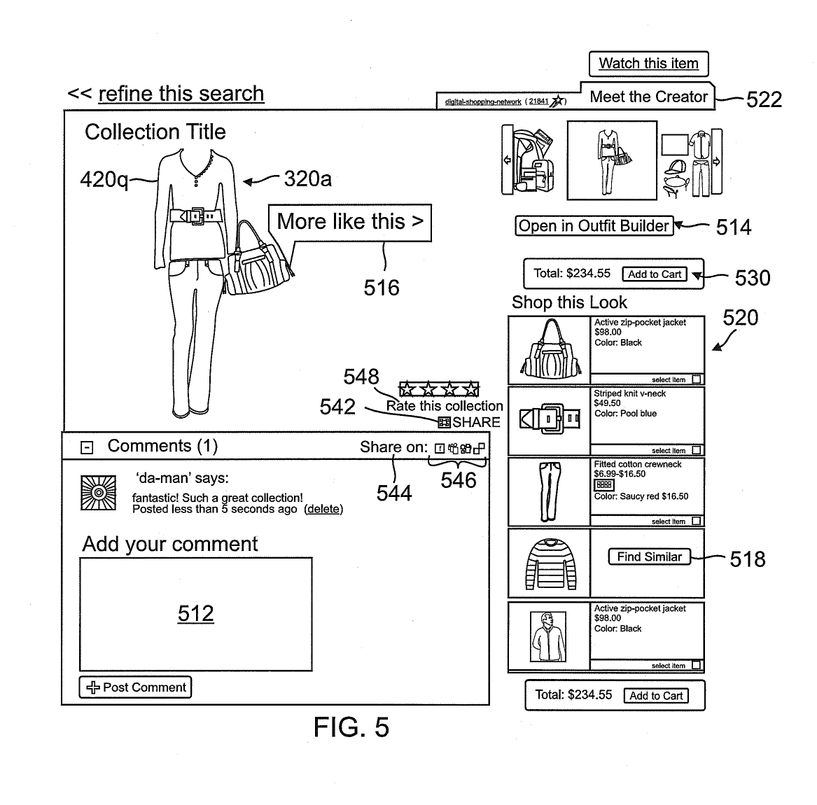

Referring now to FIG. 5, an example of a screen shot of a presentation of the new collection 320a of FIG. 4 is illustrated according to an embodiment of the present disclosure.

Once a new object or new collection 320a has been saved persisting the associated data or arrangement therein under a “Collection Title,” the presentation of new collection 320a may be represented in various ways. The new collection 320a represents a new e-commerce object that may inherit new characteristics.

In an example in a context where consumers may bid on items online, a seller of items may create new collections comprising various items or inventory that may be related to the seller. A buyer may independently create his or her own collections and choose items or inventory from various sources as desired.

New collection 320a may not be limited for viewing or use to an exclusive user. For example, new collection 320a may be extended to other users or affiliates with granted permission. According to one or more embodiments, new collection 320a may carry certain ownership and rights based on who the owner is. A user of new collection 320a may be the owner of the new collection 320a and may be a buyer, a seller or an affiliate. Each user would have his or her own access to new collection 320a including the items or inventory making up new collection 320a therein as well as permissions to save or persist such new collection 320a. The permissions would enable the representation of new collection 320a to show up on different parts of the site.

By executing an “Open in Outfit Builder” operation 514, a user having permission may be enabled to view and re-edit new collection 320a. If the user is the author or creator of new collection 320a, he or she may proceed with editing of new collection 320a; however, a non-author user, with appropriate permission, may first save the new collection 320a and then re-edit. Also, the collection author may be shown, for example, through a “Meet the Creator” operation 522.

In an embodiment, new collection 320a may be selected and represented in a social network via a network such as the Internet. For example, new collection 320a may be selected and represented by executing the “Share” operation 542 or the “Share on” operation 544. “Share on” operation 544 allows the user to choose a desired social network indicated by icons 546 listed therein. The “Share” operation 542 and “Share on” operation 544 allow new collection 320a to be distributed across a network such as the Internet while preserving the URL's and locations of the items or inventory of which new collection 320a is comprised.

In another aspect, new collection 320a may be rated by using, for example, a “Rate this collection” operation 548 and be indicated by a star rating wherein new collection 320a as well as items making up new collection 320a may gain popularity and thus be indexed back into search results while maintaining all the relevant metadata associated with that item.

The sharing operations (542, 544, 546) and rating operation (548) described above may promote new collection 320a within an ecosystem of multiple collections.

In addition, users may rate or post comments regarding new collection 320a. For example, users may post comments in comment box 512 regarding new collection 320a.

Because information such as metadata associated with each item making up new collection 320a is maintained or preserved, users are able to “Shop this Look” conveyed by new collection 320a on an item-by-item basis as illustrated in block 520. Conveniently, users may buy the entire new collection 320a by adding the new collection to a shopping cart, for example, by using an “Add to Cart” control 530.

If a specific item (or inventory) making up new collection 320a is not available for buying, for example, a sweater 420q that is a part of new collection 320a, an information query may be turned on based on that item's metadata by using a “Find Similar” operation 518 to search for and view similar items.

As described above, new collection 320a may be re-edited allowing any future buyer a way to create his or her own new collection based on the original new collection 320a without affecting the original new collection 320a. This ability to modify the original new collection 320a may lead to a viral creation of collections across an e-commerce experience.

Throughout the lifecycle of new collection 320a, additional services, advertising, sponsorship and services may be built off of new collection 320a. For example, inventory such as indicated by “Find More like this” operation 516 may be resolved on the items within new collection 320a. Based on inventory and business logic, links may be dynamically crated to direct future buyers to items that relate to the original new collection 320a.

The resulting new object or new collection 320a enables an entire ecosystem of personalized and richer objects to be indexed and displayed within a marketplace such as eBay. Instead of a photograph representing a single item for sale as portrayed by most online business entities, embodiments of the present disclosure provide an entire new collection of items that may be sold together or separately.

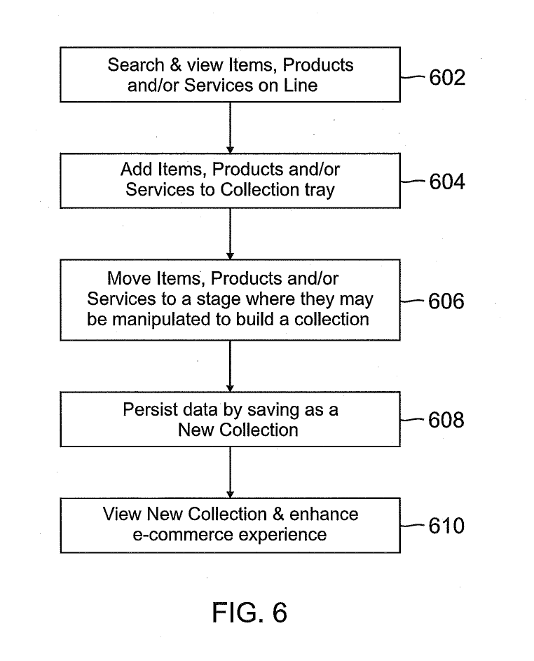

FIG. 6 is a flowchart illustrating an e-commerce experience for creating and managing a collection according to an embodiment of the present disclosure.

Referring to FIG. 6 (and FIGS. 1 and 2), in block 602, a user 102 may search and view items, products and/or services available through one or more online or network-based business entities. In an example, user 102 may search for clothing items such as t-shirts, which may be viewed by color, and size and quantity may be selected. Similar items may also be found and viewed.

In block 604, user 102 may add items, products and/or services into a collection tray 240 at any time so that user 102 may leverage the items, products and/or services in the collection tray 240. Items, products and/or services in the collection tray 240 may be sorted, organized and filtered in order to locate the proper item, product and/or service.

In block 606, user 102 may expand or maximize collection tray 240 and move (for example, by selecting and dragging) selected items, products and/or services directly to a freeform stage 310 where they can be manipulated to build a collection.

In block 608, once a collection is completed, a snapshot may be taken and the collection may be saved. Information or metadata associated with each item, product and/or service making up the collection is maintained or preserved. Persisting the data or arrangement of the collection may be done automatically, or may be executed by pressing a “saving” control, allowing the entire collection and attributes to be written as a new collection.

In block 610, user 102 may view new collections on a landing page wherein items, products and/or services making up the new collection may be shown. Other collections may be shown therein as well.

According to embodiments of the present disclosure, the use of a new collection may enhance an e-commerce experience in various ways. Enhancements may include sharing a new collection with other users or friends, or on popular sites such as social network sites. The new collection may represent a new e-commerce object that may inherit new characteristics. For example, by representing the new collection in a social network, each of the items, products and/or services used in the collection may be rated and gain popularity and thus be indexed back into search results with all the relevant metadata associated with that item, product and/or service.

Other enhancements to the e-commerce experience include allowing for entire new collections to be added to, for example, a shopping cart, and allowing re-editing or modifying of the new collections so that any future user may create his or her own new collection based on the original collection without affecting the original collection. This ability to modify the original collection may lead to a viral creation of collections across an ecommerce experience.

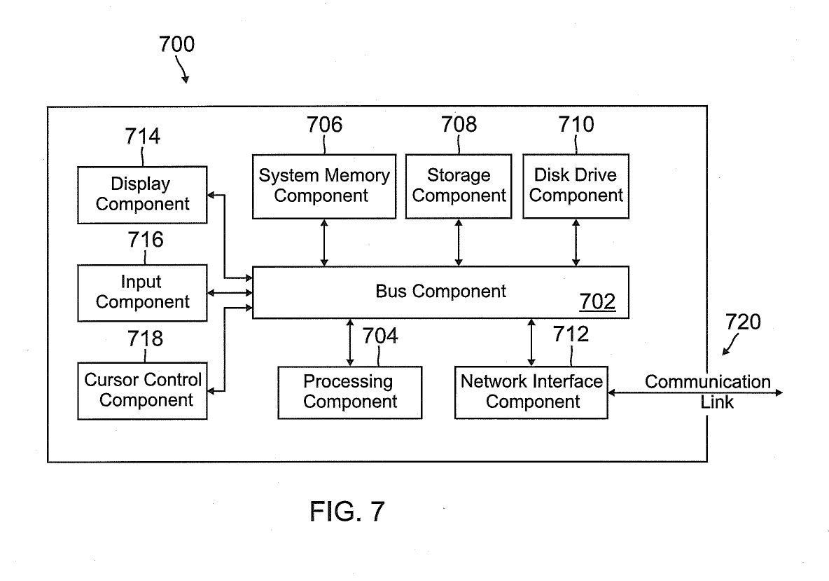

FIG. 7 is a block diagram of a system 700 suitable for implementing embodiments of the present disclosure, including client device 120, one or more merchant devices 140 and payment processing device 180. System 700, such as part of a cell phone, personal computer and/or a network server, includes a bus 702 or other communication mechanism for communicating information, which interconnects subsystems and components, such as a processing component 704 (e.g., processor, micro-controller, digital signal processor (DSP), etc.), a system memory component 706 (e.g., RAM), a static storage component 708 (e.g., ROM), a network interface component 712, a display component 714, an input component 716 (e.g., keypad or keyboard), and a cursor control component 718 (e.g., a mouse pad).

In accordance with embodiments of the present disclosure, system 700 performs specific operations by processor 704 executing one or more sequences of one or more instructions contained in system memory component 706. Such instructions may be read into system memory component 706 from another computer readable medium, such as static storage component 708. These may include instructions to create, display, manipulate and/or share collections of e-commerce items. In other embodiments, hard-wired circuitry may be used in place of or in combination with software instructions to implement the embodiments of the present disclosure.

Logic may be encoded in a computer readable medium, which may refer to any medium that participates in providing instructions to processor 704 for execution. Such a medium may take many forms, including but not limited to, non-volatile media, volatile media, and transmission media. In various implementations, volatile media includes dynamic memory, such as system memory component 706, and transmission media includes coaxial cables, copper wire, and fiber optics, including wires that comprise bus 702. Memory may be used to store visual representations of the different collections of e-commerce items. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the present disclosure, execution of instruction sequences to practice the embodiments of the disclosure may be performed by system 700. In various other embodiments, a plurality of systems 700 coupled by communication link 720 (e.g., network 160 of FIG. 1, LAN, WLAN, PTSN, or various other wired or wireless networks) may perform instruction sequences to practice the embodiments of the present disclosure in coordination with one another. System 700 may transmit and receive messages, data, information and instructions, including one or more programs (i.e., application code) through communication link 720 and communication interface 712. Received program code may be executed by processor 704 as received and/or stored in disk drive component 710 or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. It is contemplated that various alternate embodiments and/or modifications to the present disclosure, whether explicitly described or implied herein, are possible in light of the disclosure.

Having thus described embodiments of the disclosure, persons of ordinary skill in the art will recognize that changes may be made in form and detail without departing from the scope of the disclosure and is limited only by the claims.

What is claimed is:

1. A system for creating and managing online collections, the system comprising:
an interface component, the interface component receiving information relating to products offered at one or more websites;
a display component; and
a collection management component, the collection management component implemented using one or more processors and configured to:
receive an indication of a user selection of one or more of the products offered at the one or more websites;
responsive to the indication of the user selection, add a visual depiction of the one or more products to a collection tray via the display component;
receive an indication of a user request to alter the visual depiction of a selected product of the one or more products; and
responsive to the indication of the user request, modify the visual depiction of the selected product.

2. The system of claim 1 wherein the indication of the user selection of one or more products offered at the one or more websites includes an indication of a plurality of products offered at a plurality of websites, the plurality of websites corresponding to a plurality of product providers.

3. The system of claim 1 wherein the collection management component is configured to modify the visual depiction of the selected product by rotating the depiction of the selected product.

4. The system of claim 1 wherein the collection management component further comprises a stage depicted on the display component, wherein, in response to a user indication, one or more selected products are moved from the collection tray into the stage displayed on the display component, wherein collection(s) are built at any time in order to leverage the products available in the collection tray.

5. The system of claim 1 wherein the collection management component is configured to modify the visual depiction of the selected product by layering the depiction of the selected product.

6. The system of claim 1, wherein the collection management component is configured to modify the visual depiction of the selected product by resizing the depiction of the selected product.

7. The system of claim 1, wherein the collection management component is configured to maintain, for the selected product, its respective metadata information in response to a user request to save a collection.

8. The system of claim 1 wherein the collection management component further comprises a stage depicted on the display component, wherein the stage further comprises zoom, center and panning controls.

9. The system of claim 1 wherein, in response to receiving a user request, collections are shared via a network with other users, wherein URLs and locations of each product comprising the collections are preserved.

10. The system of claim 9 wherein the collections are adapted to be re-edited based on metadata information preserved for each product forming the collections.

11. The system of claim 1 wherein collections comprised of one or more selected products are adapted to be accessed or re-edited by other users based on indications received from a user that permissions are granted by the user or an owner of the collections.

12. A method for creating and managing online collections, the method comprising:
receiving, electronically by a processor, information relating to products offered at one or more websites;
receiving, electronically by the processor, an indication of a user selection of one or more of the products offered at the one or more websites;
responsive to the indication of the user selection, adding, electronically by the processor, a visual depiction of the one or more products to a collection tray displayed on a display component;
receiving, electronically by the processor, an indication of a user request to alter the visual depiction of a selected product of the one or more products; and
responsive to the indication of the user request, modifying, electronically by the processor, the visual depiction of the selected product.

13. The method of claim 12 further comprising receiving, electronically by the processor, a user indication of a plurality of products offered at a plurality of websites, the plurality of websites corresponding to a plurality of product providers.

14. The method of claim 12, further comprising modifying the visual depiction of the selected product by rotating the depiction of the selected product.

15. The method of claim 12, further comprising expanding the collection tray to display a stage.

16. The method of claim 12, further comprising, responsive to a user request, moving one or more selected products from the collection tray into a stage, and, in response to a user request, build collection(s) at any time in order to leverage the products available in the collection tray.

17. The method of claim 12 further comprising manipulating the selected product on a stage, the manipulating further comprising navigating the stage including zooming, centering, or panning, via one or more controls, on the selected product.

18. The method of claim 17 further comprising removing backgrounds or solid colors from photographs of the one or more products so that the manipulating in the stage is visually enhanced.

19. The method of claim 12 further comprising saving collections including maintaining respective metadata information for each product that forms the collections.

20. A non-transitory computer-readable medium comprising instructions which, in response to execution by a computer system, cause the computer system to perform a method for:
receiving, electronically by a processor, information relating to products offered at one or more websites;
receiving, electronically by the processor, an indication of a user selection of one or more of the products offered at the one or more websites;
responsive to the indication of the user selection, adding, electronically by the processor, a visual depiction of the one or more products to a collection tray displayed on a display component;
receiving, electronically by the processor, an indication of a user request to alter the visual depiction of a selected product of the one or more products; and
responsive to the indication of the user request, modifying, electronically by the processor, the visual depiction of the selected product.
